(19) United States
(12) Patent Application Publication
(10) Pub. No.: US 2023/0200356 A1
(43) Pub. Date: Jun. 29, 2023

(54) Retractable pet leash

(71) Applicant: Dongguan Jiasheng Enterprise Co., Ltd, Dongguan (CN)

(72) Inventor: Silong Chen, Dongguan (CN)

(21) Appl. No.: 17/646,458

(22) Filed: Dec. 29, 2021

(51) Int. Cl. A01K 27/00; B65H 75/40; B65H 75/44; B65H 75/48

(52) U.S. Cl. CPC A01K 27/004; B65H 75/406; B65H 75/486; B65H 75/4431

(57) ABSTRACT

A retractable pet leash comprises a shell with opposite ends, a rolling disc contained in the shell, a rope wound in the rolling disc, a locking button and a locking member; the shell is provided with a mounting hole; the locking button includes a mounting seat, a pulling member and a resetting member; the mounting seat is pivoted inside the shell; the mounting seat has a main body and a sliding slot passing through the main body; the pulling member is arranged on the mounting seat, a bottom of the pulling member passes through the sliding slot to connect the resetting member; the locking member is pivoted inside the shell and has a pivoting seat, a pivoting part, a locking part and the pressing part; the locking part cooperates with adjacent teeth of the rolling disc, the pressing part cooperates with the resetting part.

### FIELD OF THE INVENTION

The invention relates to retractable pet leash technical field, more particularly, relates to a retractable pet leash.

### BACKGROUND OF THE INVENTION

Chinese Utility Model Pat. No. 201720504070.X discloses a pet pulling rope, including a shell and a rope body, an inner wall of the shell is connected rotabaly with a rolling disc, winding the rope body by auto-rotation, The shell is provided with an outlet for receiving and releasing the rope body and a receiving and releasing button. The inner wall of the shell is provided with a limit block for limiting the rotation of the rolling disc. A spring, disposed between the limit block and the travel cavity, drives a receiving and releasing button away from the rotating disc. A sidewall of the receiving and releasing button is connected rotabaly with a locking button, and the inner wall of the shell is provided with a first locking block in the rotary range of the locking button. The sidewall of the locking button is provided with a second locking block matched with the first locking block to prevent the receiving and releasing button moving upwards. When the rope is released to a required length, press the receiving and releasing button to prevent the further rotation of the rolling disc, then the user rotates the locking button to drive the second locking block and the first locking block to butt against each other through the ascending pressure of the spring, avoid a ratchet arranged on the periphery of the rolling disc and the teeth arranged on the locking button breaking away from each other, simultaneously keep the ratchet and the teeth to be in a locking state, so that the length of the rope body can be controlled.

In the retractable pet leash in the prior art, when the receiving and releasing button is pressed, the rope is locked and can not be released or received again. However, at this time, the components such as the rolling disc will continue to rotate due to inertia, but the rotation is forced to stop, thus prone to damage. For the pets who are running and pulling the rope to release, at the moment, the pet cannot stop immediately due to the inertia, thus being hurt, even causing the people who control the retractable pet leash to be hurt.

Therefor, it is necessary to develop a new retractable pet leash to overcome the deficiencies of the prior art.

### SUMMARY OF THE INVENTION

To overcome In order to overcome the deficiencies of the prior art, the present invention provided with a retractable pet leash, through the cooperation of a locking button and a locking member cooperated with the locking button to control a rotation of a rolling disc, which realizes a flexible receiving and releasing of the rope and a control of the movement range of a pet. The retractable pet leash has the buffer function and is convenient operation.

The technical proposals of the present invention are as follows: a retractable pet leash includes a shell with opposite ends, a rolling disc contained in the shell, and a rope wound in the rolling disc, the opposite ends of the shell are provided respectively with an outlet for the rope and a handle for the use to hold the retractable pet leash.

The retractable pet leash also includes a locking button and a locking member. The shell is provided with a mounting hole. The locking button includes a mounting seat, a pulling member and a resetting member. The mounting seat is pivoted inside the shell and mounted under the mounting hole. The mounting seat has a main body and a sliding slot passing through the main body. The pulling member is arranged on the mounting seat, a bottom of the pulling member passes through the sliding slot to connect the resetting member and can slide in the mounting hole along the sliding slot. The locking member is pivoted inside the shell and has a pivoting seat and a pivoting part, a locking part and the pressing part arranged on the pivoting seat. The locking part cooperates with adjacent teeth of the rolling disc, the pressing part cooperates with the resetting part, thereby locking and releasing the rolling disc and bring the rolling disc to turn around.

The locking member is pivoted inside the shell by a first shaft. The first shaft is sleeved with a torsional spring. The shell is provided with a stopper, one end of the torsional spring is against with the stopper, the other end of the torsional spring is against the pivoting seat, the pivoting part is pivoted on the first shaft.

The other end of the mounting seat is convex with a limit part. The shell is provided with an elastic part below the limit part. Press the pulling member to push the mounting seat to rotate to the limit part and contact the elastic part, and it can not continue to rotating for the stop from the elastic part. At this time, the resetting part pushes the pressing part to drive the locking member to rotate until a part of the locking part inserts between the adjacent teeth of the rolling disc. The rolling disc can rotate and wind up the rope, but can not release the rope. After the pressing power disappears, the elastic part pushes the mounting seat to reset, the locking part takes off the adjacent teeth of the rolling disc to release the rolling disc.

The pulling member has a pulling plate, a bottom of the pulling plate is provided with a connecting part. A connecting column and a casing column are disposed below the connecting part. The resetting number also includes a spring and a resetting plate. The middle of the resetting plate is provided with a containing slot, opposite sidewalls of the containing slot are arranged respectively a lift groove. The resetting plate matches with the containing slot in shape and is provided with an end part received smoothly in the lift groove. The spring is contained in the containing slot with one end attaching to the resetting plate, the other end extending out the containing slot to sleeve with the casing column; the resetting seat is provided with a block position at a side of the containing slot. When the rolling disc is locked, the pressing part is in the blocking position; when the rolling disc is released or in a resetting state, the pressing part is against the resetting plate.

The pulling member has a pulling plate, a bottom surface of the pulling plate is provided with a connecting part. The connecting column is arranged below the connecting part, which passes through the sliding slot and connect the resetting member by the connecting columns.

The resetting member has a resetting seat, the top of the resetting seat is provided with the containing slot, into which the connecting part is inserted. The resetting seat is provided with connecting hole at the bottom of the containing slot. The connecting column is inserted into the connecting hole.

A top surface of the pulling plate is provided with a boss with multiple of bumps.

The connecting part and the containing slot is provided respectively with grooves and ridges matched with each other.

The pivoting seat is an open groove surrounded by a bottom plate and two sidewalls , one end of the two sidewalls are provided respectively with the pivoting part. The other end of the torsional spring is against the bottom plate of the pivoting part. The bottom plate of the pivoting part is provided wit the pressing part.

A tip of the locking part is set as an intersection angle with a first blocking surface and a second blocking surface. The teeth of the rolling disc are fan-shaped with a first fitting surface and a second fitting surface. The first blocking surface matches with the first fitting surface, the second blocking surface matches with the second fitting surface.

The advantages of the present invention are as follows: the retractable pet leash in the present invention controls the rotation of the rolling disc by setting the locking button and locking member matched with each other, push the pulling member towards the handle, the resetting member pushes the pressing part to rotate the locking member and insert the locking part into the adjacent teeth of the rolling disc, thereby locking the rolling disc and prevent it from rotating. Push the pulling member toward the outlet for the rope, the resetting member releases the pressing part, the locking member rotates to reset so as to the locking part taking off the adjacent teeth of the rolling disc, thereby releasing the rolling disc. Press down the pulling part to push the mounting seat to rotate, and drive the resetting member to press the locking part into the adjacent teeth of the rolling disc, so that the rolling disc can only return to wind the rope, but can not release the rope, which realizes flexible collection and release of the rope, control the motion range of pet, it is convenient operation.

### BRIEF DESCRIPTION OF THE DRAWINGS

FIG. 1 is a perspective view of the retractable pet leash according to the present invention.

FIG. 2 is a perspective view of the retractable pet leash removing a part of the shell according to the present invention.

FIG. 3 is an enlarge view at the position A in FIG. 2, which shows the rolling disc in the locking state.

FIG. 4 shows the rolling disc in the releasing state.

FIG. 5 shows the rolling disc in the rotary state.

FIG. 6 shows a perspective view of the pulling member according to the present invention.

FIG. 7 shows a perspective view of the mounting seat according to the present invention.

FIG. 8 shows a decomposition view of the resetting member according to the present invention.

FIG. 9 shows a perspective view of the resetting seat according to the present invention.

FIG. 10 shows the other perspective view of the resetting seat according to the present invention.

FIG. 11 shows the perspective view of that the rolling disc and the locking member cooperate with each other according to the present invention.

### DETAILED DESCRIPTION OF ILLUSTRATED EMBODIMENTS

In order to make the purpose, the technical scheme and the technical effect of the present invention are more clear, and they are further explained in combination with the specific embodiments below. It should be understood that the specific embodiments described herein are used only for interpreting the present invention and not to define the present invention.

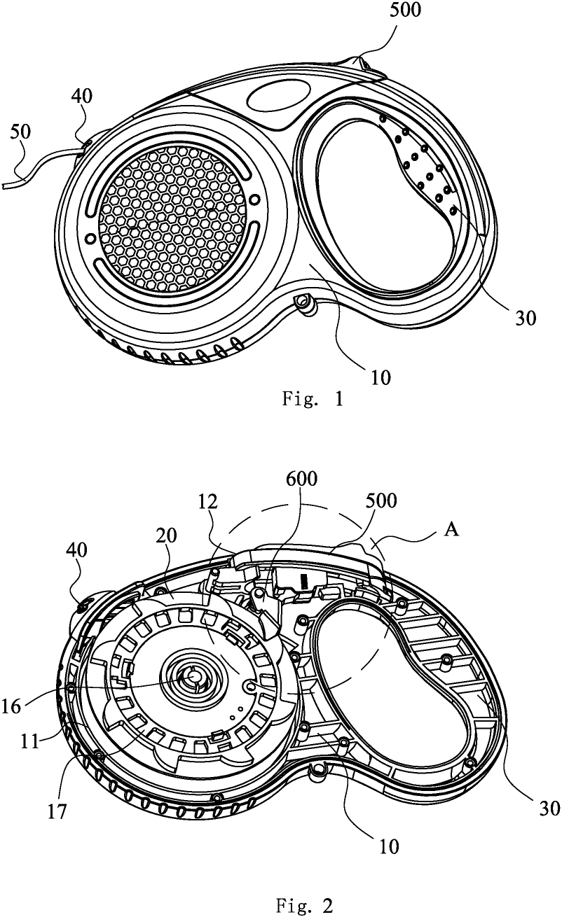

Referring to FIG. 1, a retractable pet leash includes a shell 10 with opposite ends, a rolling disc 20 contained in the shell 10, and a rope 50 wound in the rolling disc 20. The shell 10 is formed a chamber 11. The rolling disc 20 is contained in the chamber 11 and connected rotatably in an inner wall of the shell 10. One end of the shell 10 is hollowed out and formed a handle 30 for the user to hold the retractable pet leash. The other end of the shell 10, opposite to the handle, is provided with an outlet 40 for the rope The rope 50 winds the rolling disc. If the rolling disc is rotated in the direction of the outlet 40, that is positive direction, to release the rope. If the rolling disc is rotated in the direction of the handle 30, that is the reverse direction, to wind the rope. The end of the rope 50 extends out of the chamber 11 is used for tying the pet.

Referring to FIG. 2, the shell 10 is provided with a locking button 500 and a locking member 600, which are cooperated with each other to control the rolling disc 20 to rotate or stop, thereby winding or releasing the rope 50 to control the movement range of the pet.

Referring to FIG. 2, the locking button 500 is set between the handle 30 and the outlet 40. When holding the handle 30, the user’s palm fits the handle 30, the user’s four fingers pass through the empty place between the handle 30 and the shell 10 and bend to hold the handle, and the user thumb can be naturally placed on the locking button 500. The structure is convenient for operating the locking button 50, thereby releasing and winding the rope, and adjust the the movement range of the pet.

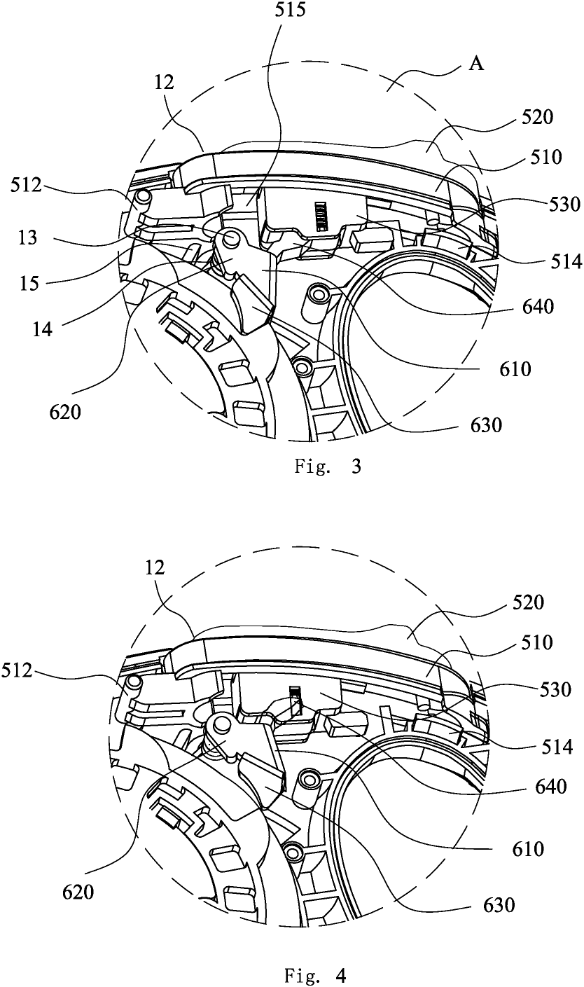

Referring to FIG. 2 and FIG. 3, the shell 10 is provided with a mounting hole 12. The locking button 500 is mounted in the mounting hole 12. The The locking button 500 includes a mounting seat 510, a pulling member 520 and a resetting member 530. The mounting seat 510 is pivoted inside the shell 10 and mounted under the mounting hole 12. One end of the mounting seat 510 has a sliding slot 511 passing through its main body. The pulling member 520 is arranged on the mounting seat 510, a bottom of the pulling member 520 passes through the sliding slot 511 to connect the resetting member 530 and can slide in the mounting hole 12 along the sliding slot 511.

Specifically, one end of the mounting seat 510 is provided with a first shaft 512, the shell 10 is provided with a hole for the first shaft to pass through so that the mounting seat 510 can be rotated. Further, the other end of the mounting seat 510 is provided with a limit part 513. The shell 10 is provided with an elastic part 514 below the limit part 513. The mounting seat 510 rotates around the first shaft 512 to until the limiting 513 is against the elastic part 514, the elastic part 514 blocks the mounting seat 510 to rotate, thereby limiting the mounting seat at a specific space.

Further, a second sliding groove 515 is arranged below the mounting seat 510. The resetting member 530 is contained partly in the second sliding groove 515. The second sliding groove 515 is limited the movement range of the resetting member 530.

Referring to FIG. 7, the pulling member 520 has a pulling plate 521, a top surface of which is provided with a boss 522 with multiple of bumps 523. The bumps 523 is ergonomic for the user to pull it. A bottom surface of the pulling plate 521 is provided with a connecting part 522. A connecting column 522 and a casing column 524 is disposed below the connecting part 522, the connecting part 522 passes through the sliding slot 511 and connect the resetting member 530 by the connecting columns 525.

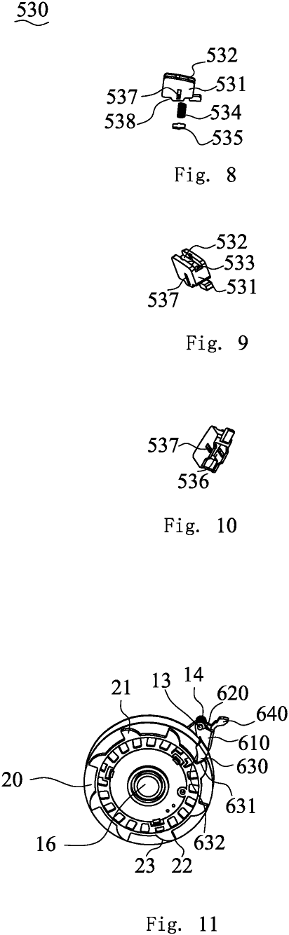

Specifically, referring to FIG. 8, FIG. 9 and FIG. 10, the resetting member 530 has a resetting seat 531, the top of the resetting seat 531 is provided with an upper containing slot 532, into which the connecting part 524 is inserted. Preferably, the connecting part 524 and the upper containing slot 532 is provided respectively with grooves and ridges matched with each other, thereby the connecting part 524 and the upper containing slot 532 are connected stably and not easy to take off. The resetting seat 531 is provided with a connecting hole 533 at the bottom of the upper containing slot 532. The connecting column 525 is inserted into the connecting hole 533, thereby realizing the connection of the resetting member 530 and the pulling member 520. When the pulling or pressing the pulling member 520, the resetting member 530 can be moved synchronously with the pulling member 520.

Further, the resetting number 530 also includes a spring 534 and a resetting plate 535. The middle of the resetting plate 531 is provided with a lower containing slot 536, opposite sidewalls of the lower containing slot 536 are arranged respectively a lift groove 537. The resetting plate 535 matches with the lower containing slot 536 in shape and is provided with an end part received smoothly in the lift groove 537. The spring 534 is contained in the lower containing slot 536 with one end against the resetting plate 535, the other end extending out the lower containing slot 536 to sleeve with the casing column 526; the resetting seat 531 is provided with a block position 538 at a side of the containing slot 536.

Referring to FIG. 11, the locking member 600 is pivoted inside the shell 10 and lies between the rolling disc 20 and the locking button 500. The locking member 600 has a pivoting seat 610 and a pivoting part 620, a locking part 630 and the pressing part 640 mounted on the pivoting seat 610. Specifically, The shell 10 is provided the second shaft 13 wound with a torsional spring 14. The shell 10 is provided with a stopper 15, one end of the torsional spring 14 is against with the stopper 15, the other end of the torsional spring 14 is against the pivoting seat 610, the pivoting part 620 is pivoted on the second shaft 13. The locking part 630 cooperates with adjacent teeth 21 of the rolling disc 20, the pressing part 640 cooperates with the resetting part 530.

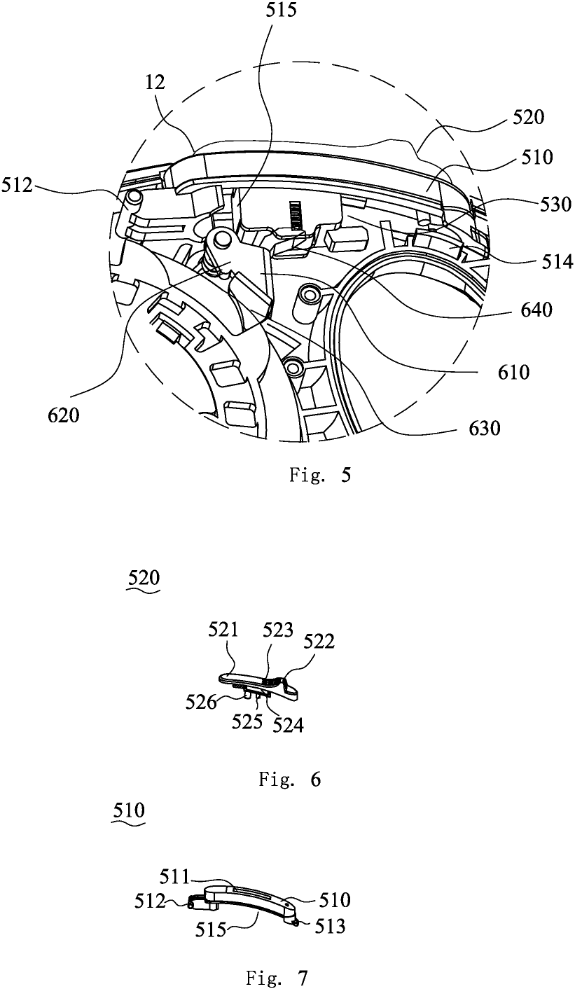

Referring to FIG. 3, FIG. 4 and FIG. 5, push the pulling member 520 toward the handle 30, the pulling member 520 brings the resetting member 530 to move toward the handle 30 along the sliding slot 511 of the mounting seat 510. The pressing part 640 enters the block position 538, the resetting member 520 pushed the pressing part 640 to rotate the locking member 600 and insert the locking part 630 into the adjacent teeth 21 of the rolling disc 20, thereby locking the rolling disc 20 and prevent it from rotating, the rope 50 is released or wound. Push the pulling member 520 toward the outlet 40 for the rope, the pulling member 520 brings the resetting member 520 to move toward the outlet 40 of the rope 50 along the sliding slot 511 of the mounting seat 510. The pressing part 640 is below the resetting member 530, the resetting member 530 releases the pressing part 640, the locking member 600 resets, and the locking part 630 extends out the adjacent teeth 21 of the rolling disc 20, thereby releasing the rolling disc 20. The rolling disc 20 can rotate in the positive direction to release the rope 50, and in the reverse direction to wind the rope 50.

Press the pulling member 520 to push the mounting seat 510 to rotate around the first shaft 512 to the limit part 513 and contact the elastic part 514, and it can not continue to rotating for blocking from the elastic part 514. At this time, the resetting part 530 pushes the pressing part 640 to drive the locking member 600 to rotate until a part of the locking part 630 inserts between the adjacent teeth 21 of the rolling disc 20. If the rolling disc 20 rotates in the positive direction to release the rope, the locking part 630 is blocked, if the rolling disc 20 rotates in the reverse direction to wind up the rope, the teeth 21 of the rolling disc 20 pushed the locking part 630, the pressing part 640 pushes the resetting plate 535 to compress the spring 534 and rise, thereby that the locking member 600 can be rotated until the locking part 630 extends out the the teeth 21 of the rolling disc 20, which realizes the reverse rotation of the rolling disc 20 to wind the rope. After the pressing power disappears, the spring 534 resets to push the resetting plate 535, the elastic member 514 also pushes the mounting seat 510 to reset, the locking part 630 takes off the adjacent teeth 21 of the rolling disc 200 to release the rolling disc. The retractable pet leash in the present invention realizes to release and wind the rope 50 by pressing the pulling member continuously or the pressing member repeatedly.

Specifically, the pivoting seat 610 is an open groove 612 surrounded by a bottom plate and two sidewalls 611, one ends of the two sidewalls 611 extend respectively the pivoting part 620, the other ends of the two sidewalls 611 extend respectively the locking part 630. The bottom plate of the pivoting seat 610 extends the pressing part 640. The pivoting part 620 is provided with a mounting hole and mounted rotatably on the first shaft 13 passing through the mounting hole. The other end of the torsional spring 14 is against the bottom plate of the pivoting seat 610.

A tip of the locking part 630 is set as an intersection angle with a first blocking surface 631 and a second blocking surface 632.The teeth 21 of the rolling disc 20 are fan-shaped with a first fitting surface 22 and a second fitting surface 23. When the rolling disc 20 is locked, the first fitting surface 22 is blocked by the first blocking surface 631, or the second fitting surface 23 is blocked by the second blocking surface 632, thereby that the rolling disc 20 can not be rotated. When the rolling disc 20 is released, the locking part 630 extends out the teeth 21, the rolling disc 20 can be rotated in positive direction to release the rope 50 and in a reverse direction to wind the rope. When the locking part 630 inserts between the teeth of the rolling disc, if the rolling disc 20 rotates in reverse direction, the second fitting surface 23 pushes the the second blocking surface 632 so that the the locking part 630 extends totally out between the teeth 21, thereby the rolling disc 20 can rotate normally in the reverse direction. However if the rolling disc 20 rotates in the positive direction, the first fitting surface 22 pushes the first blocking surface 631. The resistance of the torsion spring 14 to the locking member 600 can not be overcome so that the rolling disc 20 can not rotate normally

The rolling disc includes a third shaft 16 mounted on the shell 10 and a disc 17 with teeth 21 mounted on both ends of the shaft, the teeth 21 is arranged on the periphery of the disc. The third shaft 16 is sleeved with a vortex spring(not shown in FIGS). When the rolling disc 20 is released, a force overcomes the resistance of the vortex spring to the rolling disc and drives it to rotate in the positive direction to release the rope 50 or the vortex spring pushed the rolling disc to rotate in a reverse direction to wind up the rope 50.

The above contents are a further detailed explanation of the invention in combination with the specific preferred embodiment, and it cannot be determined that the specific implementation of the invention is limited to these explanations only. For those skilled in the prior art of the invention, the structures can be flexible and the series of products can be derived without the absence of the conception of the invention. Only a number of simple deductions or replacements shall be considered to belong to the scope of protection determined by the claim submitted in the present invention.

What is claimed is:

1. A retractable pet leash, comprising a shell with opposite ends, a rolling disc contained in said shell, and a rope wound in said rolling disc, said opposite ends of said shell is provided respectively with an outlet for said rope and a handle, wherein, also comprising a locking button and a locking member; said shell is provided with a mounting hole; said locking button includes a mounting seat, a pulling member and a resetting member; said mounting seat is pivoted inside said shell and mounted under said mounting hole; said mounting seat has a main body and a sliding slot passing through said main body; said pulling member is arranged on said mounting seat, a bottom of said pulling member passes through said sliding slot to connect said resetting member and can slide in said mounting hole along said sliding slot; said locking member is pivoted inside said shell and has a pivoting seat and a pivoting part, a locking part and said pressing part arranged on said pivoting seat; said locking part cooperates with adjacent teeth of said rolling disc, said pressing part cooperates with said resetting part, thereby locking and releasing said rolling disc and drive said rolling disc to turn around.

2. The retractable pet leash according to claim 1, wherein said locking member is pivoted inside said shell by a first shaft; said first shaft is sleeved with a torsional spring; said shell is provided with a stopper, one end of said torsional spring is against with said stopper, the other end of said torsional spring is against said pivoting seat, said pivoting part is pivoted on said first shaft.

3. The retractable pet leash according to claim 1, wherein said mounting seat is provided with a limit part; said shell is provided with an elastic part below said limit part; press said pulling member to push said mounting seat to rotate to said limit part and contact said elastic part, and it can not continue to rotating for blocking from said elastic part. at this time, said resetting part pushes said pressing part to drive said locking member to rotate until a part of said locking part inserts between said adjacent teeth of said rolling disc; said rolling disc can rotate and wind up said rope, but can not release said rope. after said pressing power disappears, said elastic part pushes said mounting seat to reset, said locking part takes off said adjacent teeth of said rolling disc to release said rolling disc.

4. The retractable pet leash according to claim 3, wherein said pulling member has a pulling plate, a bottom of said pulling plate is provided with a connecting part; a connecting column and a casing column are disposed below said connecting part; said resetting number also includes a spring and a resetting plate; said middle of said resetting plate is provided with a containing slot, opposite sidewalls of said containing slot are arranged respectively a lift groove; said resetting plate matches with said containing slot in shape and is provided with an end part received smoothly in said lift groove; said spring is contained in said containing slot with one end attaching to said resetting plate, the other end extending out said containing slot to sleeve with said casing column; said resetting seat is provided with a block position at a side of said containing slot; when said rolling disc is locked, said pressing part is in said blocking position; when said rolling disc is released or in a rotating state, said pressing part is against said resetting plate.

5. The retractable pet leash according to claim 1, wherein said pulling member has a pulling plate, a bottom surface of said pulling plate is provided with a connecting part; said connecting column is arranged below said connecting part, which passes through said sliding slot and connect said resetting member by said connecting columns.

6. The retractable pet leash according to claim 5, wherein said resetting member has a resetting seat, said top of said resetting seat is provided with said containing slot, into which said connecting part is inserted; said resetting seat is provided with connecting hole at said bottom of said containing slot; said connecting column is inserted into said connecting hole.

7. The retractable pet leash according to claim 5, wherein a top surface of said pulling plate is provided with a boss with multiple of bumps.

8. The retractable pet leash according to claim 5, wherein said connecting part and said containing slot is provided respectively with grooves and ridges matched with each other.

9. The retractable pet leash according to claim 1, wherein said pivoting seat is an open groove surrounded by a bottom plate and two sidewalls, said two sidewalls are provided respectively with said pivoting part; said bottom plate of said pivoting part is provided with said pressing part.

10. The retractable pet leash according to claim 1, wherein a tip of said locking part is set as an intersection angle with a first blocking surface and a second blocking surface; said teeth of said rolling disc are fan-shaped with a first fitting surface and a second fitting surface; said first blocking surface matches with said first fitting surface, said second blocking surface matches with said second fitting surface.
